(19) United States
(12) Patent Application Publication
(10) Pub. No.: US 2023/0091243 A1
(43) Pub. Date: Mar. 23, 2023

(54) ULTRASONIC SENSOR, PARKING ASSISTANCE SYSTEM, AND SIGNAL PROCESSING METHOD

(71) Applicant: HYUNDAI MOBIS CO., LTD., Seoul (KR)

(72) Inventor: Tae Ho LEE, Yongin-si (KR)

(73) Assignee: HYUNDAI MOBIS CO., LTD., Seoul (KR)

(21) Appl. No.: 17/837,738

(22) Filed: Jun. 10, 2022

(30) Foreign Application Priority Data
Sep. 17, 2021 (KR) 10-2021-0124903

(51) Int. Cl. G01S 15/931; B60W 30/06; G01S 15/08; G01S 7/52

(52) U.S. Cl. CPC G01S 15/931; B60W 30/06; G01S 15/08; G01S 7/52077; G01S 2015/932; B60W 2420/54

(57) ABSTRACT

Disclosed are an ultrasonic sensor, a parking assistance system including the ultrasonic sensor, and a signal processing method, the ultrasonic sensor being provided with two different signal processing paths referred to as a data compression unit and a data extractor and transmitting both processed signal data to a controller by a data transmitter, thereby complementing the advantages of each signal processing path to enhance the precision of the detection result of the sensor.

### CROSS-REFERENCE TO RELATED APPLICATIONS

The present application claims priority to Korean Patent Application No. 10-2021-0124903, filed Sep. 17, 2021, the entire content of which is incorporated herein for all purposes by this reference.

### BACKGROUND

### 1. Technical Field

The present invention relates to an ultrasonic sensor, a parking assistance system including the ultrasonic sensor and a signal processing method, the ultrasonic sensor being provided with two different signal processing paths referred to as a data compression unit and a data extractor and transmitting both processed signal data to a controller by a data transmitter, thereby complementing the advantages of each signal process path to enhance the precision of a detection result of the sensor.

### 2. Discussion of Related Art

Sensors such as ultrasonic sensors are installed on the front, rear, side, either front or rear bumper, radiator grille, and doors of a vehicle to detect objects and obstacles during parking or stopping. Generally, a parking assistance system employs such ultrasonic sensors. Further, object detection by an ultrasonic sensor may be used for identifying nearby objects in implementing autonomous driving.

Ultrasonic sensors transmit a raw waveform or time-of-flight (ToF) to a controller. Analog raw waveforms are susceptible to noise entering from outside during the transmission process, and in recent years, digital ultrasonic sensors that extract ToF from the sensor and transmit the ToF in a digital form are commonly used.

However, as the function of a parking application that used to be limited to the simple warning of parking distance has extended to autonomous driving and autonomous parking, there is a need to transmit a larger amount of information from the sensor to the controller than before. However, conventional digital ultrasonic sensors only transmit a limited amount of information like ToF, which simply allows the determination of distance alone and fails to help determine a concrete shape of an object accurately, thereby proving to be unsuitable for high-performance autonomous parking and autonomous driving systems.

On the other hand, digital ultrasonic sensors transmitting a raw waveform are available, but conversion to a digital signal poses a problem of the increased amount of data in proportion to the sampling rate and resolution of the ADC. Therefore, it is impossible to transmit the raw waveform as it is, and data compression is a must for communicating information without delay. Some information between frames is inevitably lost in the compression process.

Further, unless data is compressed, the bandwidth limitation of the ultrasonic sensor necessitates the use of communication such as CAN/LVDS/Ethernet, which is expensive communication and pushes up the sensor unit cost, and overall system cost increases.

The matters described above as a background of the present invention are intended only for a better understanding of the background of the present invention and are not to be taken as acknowledgment that they pertain to the conventional art already known to those skilled in the art.

### SUMMARY

An object of the present invention is to provide an ultrasonic sensor, a parking assistance system including the ultrasonic sensor, and a signal processing method, the ultrasonic sensor being provided with two different signal processing paths referred to as data compressor and data extractor and transmitting both processed signal data to a controller by a data transmitter, thereby complementing the advantages of each signal process path to enhance the precision of a detection result of the sensor.

The ultrasonic sensor disclosed in the present invention is an ultrasonic sensor transmitting an ultrasonic signal toward an object, receiving a reflection, processing received sensing source data, and transmitting the processed data to a controller and includes a data compressor compressing the sensing source data to generate source compressed data, a data extractor extracting first data from the sensing source data, and a data transmitter transmitting the source compressed data and the first data to the controller.

The data extractor may extract a time of flight (ToF) value from the sensing source data.

The data extractor may remove noise from the sensing source data and extract the ToF value from the sensing source data from which the noise is removed.

According to the present invention, the ultrasonic sensor according to the present invention may further include a first noise processor eliminating from the sensing source data reflection noise including a diffuse reflection by the ground or n-th order reflection, wherein the data extractor may extract first data from the sensing source data from which reflection noise is removed through the first noise processor.

According to the present invention, the ultrasonic sensor may further include a second noise processor eliminating electrical noise from the sensing source data, wherein the data compressor may compress the sensing source data from which the electrical noise is removed through the second noise processor to generate source compressed data.

According to the present invention, the ultrasonic sensor may further include a first noise processor eliminating noise from the sensing source data, wherein the first noise processor removes reflection noise or electrical noise from the sensing source data, the data extractor may extract first data from the sensing source data from which reflection noise or electrical noise is removed through the first noise processor, and the data compressor may compress the sensing source data from which electrical noise is removed through the first noise processor to generate source compressed data.

The data transmitter may transmit the source compressed data and first data to the controller by a serial communication method.

The data transmitter may transmit the first data during an idle period after measurement by the ultrasonic sensor.

According to the present invention, the parking assistance system including the ultrasonic sensor may include a controller receiving the source compressed data and the first data from the data transmitter of the ultrasonic sensor.

The controller may include a first processor determining a shape of an object using the source compressed data and a second processor determining the distance to an object using the first data.

The controller may further include a second noise processor processing noise of the source compressed data to generate source compressed data free of electrical noise removed through the second noise processor.

According to the present invention, a signal processing method of an ultrasonic sensor includes: compressing, by a data compressor, sensing source data to generate source compressed data; extracting, by a data extractor, first data from the sensing source data; and transmitting, by a data transmitter, the source compressed data and the first data to a controller.

According to the present invention, the ultrasonic sensor is provided with two different signal processing paths referred to as the data compressor and the data extractor and transmits both processed signal data to a controller by a data transmitter, thereby complementing the advantages of each signal process path to enhance the precision of the detection result of the sensor.

### BRIEF DESCRIPTION OF THE DRAWINGS

FIG. 1 is a configuration diagram of an ultrasonic sensor and a parking assistance system including the ultrasonic sensor according to an embodiment of the present invention.

FIG. 2 is a graph illustrating extraction by an ultrasonic sensor of a raw waveform and ToF information of an ultrasonic sensor according to an embodiment of the present invention.

FIG. 3 is a graph illustrating ground reflection of data in an ultrasonic sensor according to an embodiment of the present invention.

FIG. 4 is a graph in which ground reflection is removed from data in an ultrasonic sensor according to an embodiment of the present invention.

FIG. 5 is a graph illustrating the n-th order reflection of data in an ultrasonic sensor according to an embodiment of the present invention.

FIG. 6 is a graph in which the n-th order reflection is removed from data in an ultrasonic sensor according to an embodiment of the present invention.

FIG. 7 is a graph illustrating the electrical noise of data in an ultrasonic sensor according to an embodiment of the present invention.

FIG. 8 is a graph in which an electrical noise of data is removed in an ultrasonic sensor according to an embodiment of the present invention.

FIG. 9 is a graph illustrating the analog transmission of source compressed data and first data in an ultrasonic sensor according to an embodiment of the present invention.

FIG. 10 is a flowchart of a signal processing method of an ultrasonic sensor according to an embodiment of the present invention.

### DETAILED DESCRIPTION

Through the specification, when a component is said to “include” a certain element, it means that the part may include other elements rather than precluding other elements unless otherwise stated in particular.

In addition, terms such as ‘first’ or ‘second’ may be used in describing various components, but these terms are only intended for distinguishing the component from other components. For example, a first component may be referred to as a second component and a second component may be similarly referred to as a first component without deviating from the scope of the right under the concept of the present invention.

Configurations and operating principles of various embodiments of the disclosed invention will be described in detail with reference to the accompanying drawings in the following.

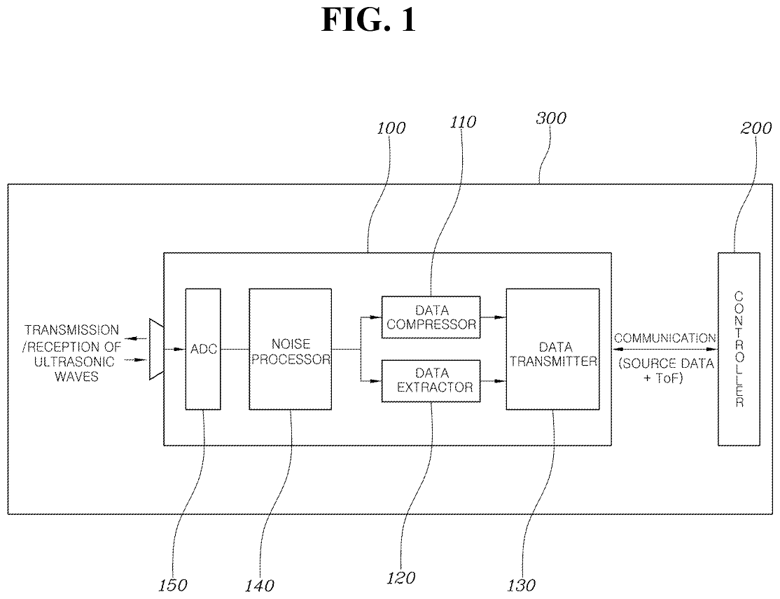

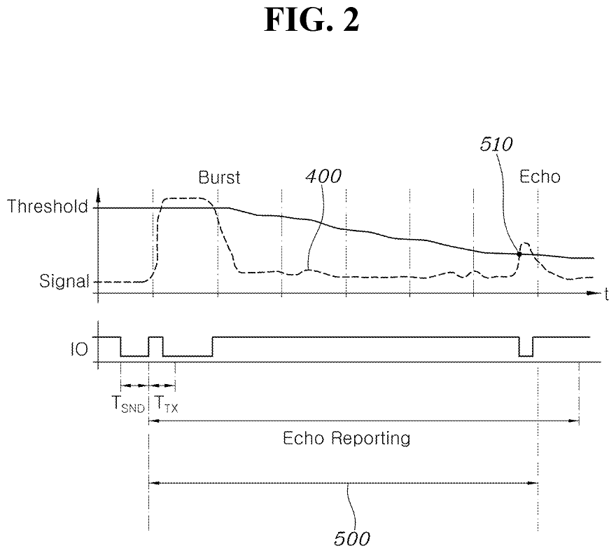

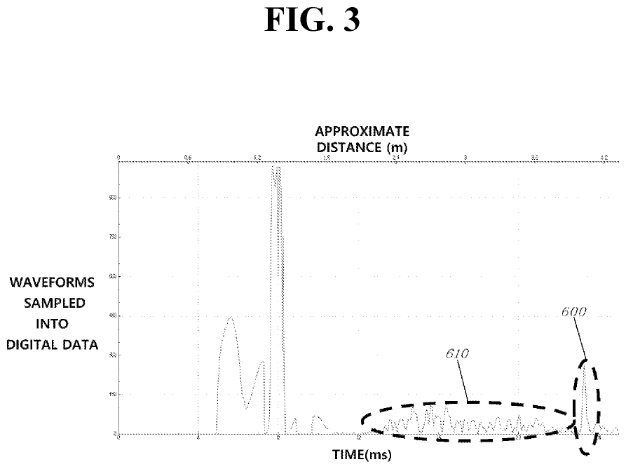

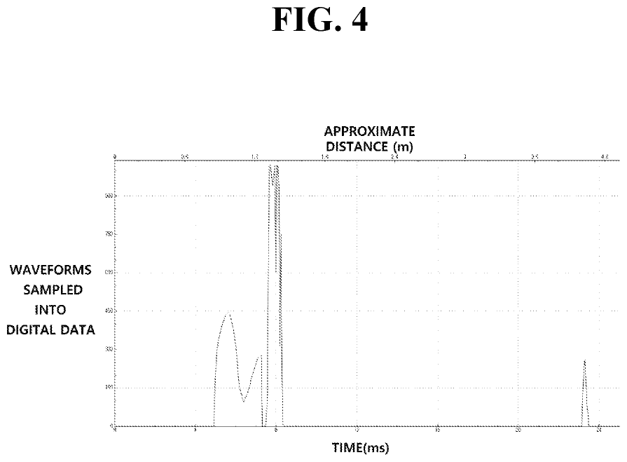

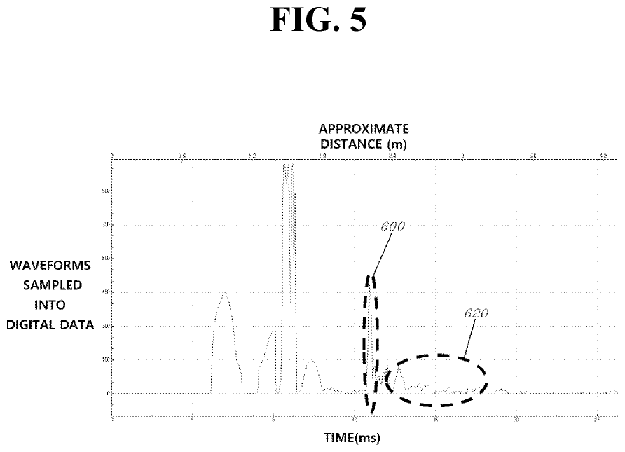

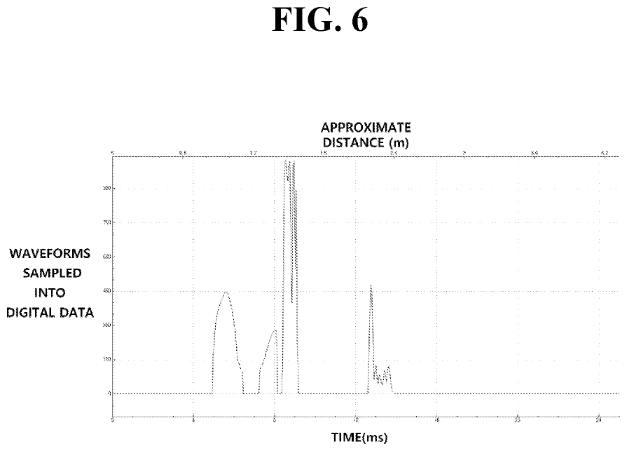

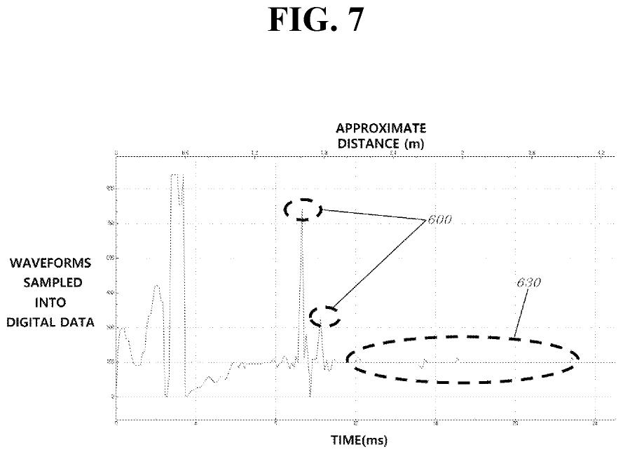

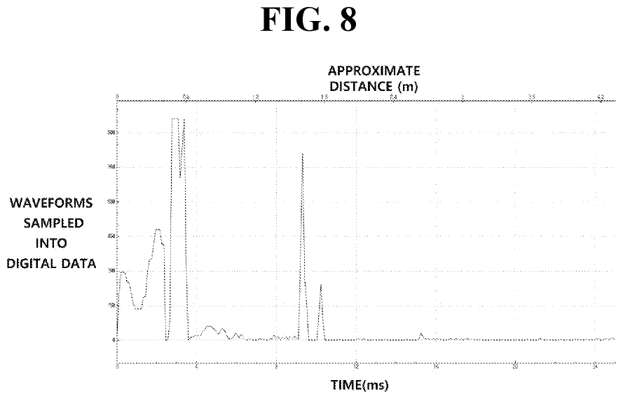

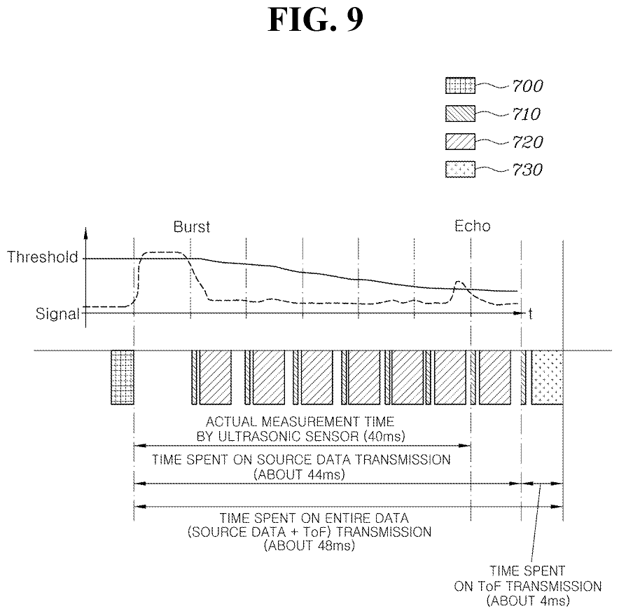

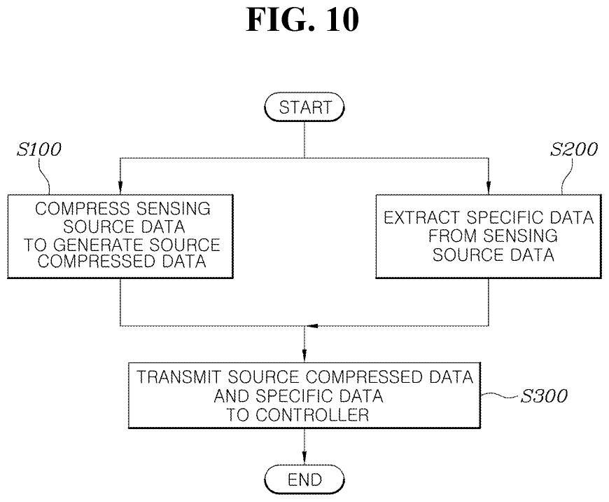

FIG. 1 is a configuration diagram of an ultrasonic sensor 100 and a parking assistance system including the ultrasonic sensor according to an embodiment of the present invention; FIG. 2 is a graph illustrating the extraction of a raw waveform 400 and ToF information 730 of an ultrasonic sensor 100 according to an embodiment of the present invention; FIG. 3 is a graph illustrating ground reflection 610 in data in an ultrasonic sensor 100 according to an embodiment of the present invention; FIG. 4 is a graph in which ground reflection 610 is removed from data in an ultrasonic sensor 100 according to an embodiment of the present invention; FIG. 5 is a graph illustrating n-th order reflection 620 in data in an ultrasonic sensor 100 according to an embodiment of the present invention; FIG. 6 is a graph in which n-th order reflection 620 is removed from data in an ultrasonic sensor 100 according to an embodiment of the present invention; FIG. 7 is a graph illustrating an electrical noise 730 in data in an ultrasonic sensor 100 according to an embodiment of the present invention; FIG. 8 is a graph in which an electrical noise 630 is removed from data in an ultrasonic sensor 100 according to an embodiment of the present invention; FIG. 9 is a graph illustrating transmission of source compressed data and first data (e.g., data related to a specific attribute or characteristic such as a distance to, location or shape of an object, etc.) in an ultrasonic sensor 100 according to an embodiment of the present invention; and FIG. 10 is a flowchart of a signal processing method of an ultrasonic sensor 100 according to an embodiment of the present invention.

FIG. 1 shows that, according to the present invention, the ultrasonic sensor 100 transmitting an ultrasonic signal toward an object, receiving a reflection, processing the received sensing source data 720, and transmitting the processed data to a controller 200 includes a data compressor 110 compressing the sensing source data 720 to generate source compressed data, a data extractor 120 extracting first data 720 from the sensing source data 720, and a data transmitter 130 transmitting the source compressed data and first data to the controller 200.

According to an embodiment of the present invention, the controller 200 may be implemented through a processor (not shown) configured to perform operations to be described below using an algorithm configured to control the operations of various components of a vehicle or a nonvolatile memory (not shown) configured to store data relating to software commands for reproducing the algorithm and the data stored in the memory. Here, the memory and the processor may be implemented as individual chips. Alternatively, the memory and the processor may be implemented as a single integrated chip. The processor may take the form of one or more processors.

A raw analog waveform 400 received by the sensor is converted into digital data via analog-digital-converter ADC 150 to generate sensing source data 720, and a problem is that the amount of data increases in proportion to the sampling rate and resolution of the ADC 150 in the conversion process. Further, unless data is compressed, the bandwidth limitation of the ultrasonic sensor 100 necessitates the use of communication such as CAN/LVDS/Ethernet, which is expensive communication and pushes up the sensor unit cost, and overall system cost increases.

According to the present invention, the data compressor 110 compresses the received sensing source data 720 to match the communication bandwidth such as to reduce the amount of data, thus allowing the use of existing low-cost communication, thereby holding down on costs. Further, generating, and transmitting to the controller 200, source compressed data allows transmission of a larger amount of information from the ultrasonic sensor 100 to the controller 200 compared with the transmission of uncompressed sensing source data 720. Accordingly, according to the present invention, the amount of data does not increase sharply, thereby saving the communication cost while safely securing all the data needed for determining the object.

As described above, when the sensing source data 720 is compressed, a problem is the loss of some information. This is because, in the case of data compression, tiny bits of information are removed and the spacing between frames is increased in the process of reducing the frame rate such that only rough data remains. The information loss in the process may decrease the precision in the determination of the distance to the target object. Accordingly, of the sensing source data 720, the first data that facilitates the determination of the distance to and location of the target object is essential data and is separately extracted without a data compression process and transmitted to the controller 200 so that information loss is prevented. Since the size of the first data is small, it may be fit for existing communication bandwidth even without a data compression process.

On the other hand, the transmission of both the source compressed data and the first data to the controller 200 by the data transmitter 130 allows the transmission of a larger amount of information compared with the transmission of only the source compressed data or the first data to the controller 200. That is, compressing and providing the source data in addition to the first data allows simultaneous determination of the shape of the object. Accordingly, the controller 200 may determine the shape of the object and accurately determine the distance while acquiring data of small size.

Further, the precision in the determination of the distance to the target object is improved based on the information of the first data so that the precision of the detection result of the ultrasonic sensor 100 is enhanced, compared with the transmission of the source compressed data only.

Specifically, according to the present invention, the data extractor 120 may extract ToF information 730 through the sensing source data 720.

FIG. 2 shows that the ToF is the information on a time difference 500 between the transmission and the reception of the ultrasonic wave by the transceiver of the ultrasonic sensor 100 as measured by transmitting an ultrasonic wave to an object and receiving a signal reflected by the object. The distance to the object may be calculated using this ToF information 730 and the characteristic of the ultrasonic wave (340 m/s).

Specifically, the reflection from an object is recognized (510) through a threshold in the sensor, and the ToF information 730 in which the reflection is detected is transmitted to the controller 200. The controller 200 may determine the linear distance to the object by multiplying half the ToF information 730 by the speed (340 m/s) of the ultrasonic wave.

That is, The ToF information 730 is the data that contains information useful in the determination of the distance to an object and enhances the precision in the determination of the distance to the target object. Further, since the distance to the target object may be obtained through a simple operation, the object may be accurately detected in a short time.

The extracted ToF information 730, unlike the source, is transmitted without compression so that information on the distance to the object is accurately transmitted. Instead, the source of large size is compressed and transmitted so that the shape may also be determined without compromising the precision of distance information.

Additionally, FIGS. 2 to 8 show the data extractor 120 may remove a noise 610, 620, 630 from the sensing source data 720 and extract the ToF information 730 from the sensing source data 720 from which the noise 610, 620, 630 is removed.

Specifically, according to the present invention, the ultrasonic sensor may further include a first noise processor 140 that removes from the sensing source data 720 reflection noise 610, 62 from the sensing source data 720 0. The first noise processor 140 may remove a diffuse reflection 610 by the ground or n-th order reflection 620 as a reflection noise 610 from the sensing source data 720, 620, wherein the data extractor 120 may extract first data from the sensing source data 720 from which reflection noise 610, 620 is removed through the first noise processor 140.

The noise 610, 620, 630 of the signal received by the sensor is classified into reflection noise 610, 620 and electrical noise 630. Of these, the reflection noise 610, 620 may be viewed as multiple reflections (n-th order reflection 620) parasitizing the diffuse noise (ground reflection 610) by ground and the main reflection waveform

The ground reflection 610 refers to a noise generated when a road has a rough reflection surface such as an asphalt roadway, and the n-th order reflection 620 is a noise that is continuously generated when the target object has a low height such as a curb. These noises are mixed and transmitted with the actual waveforms received from the object to adversely affect the obtention of the location and distance information of the object.

Accordingly, it is necessary to process the noise 610, 620, 630 in the sensing source data 720 to extract the accurate ToF information 730. Removing the noise 610, 620, 630 facilitates the obtention of the location and distance information of the object such that first data that facilitates the determination of the distance to and location of a target object is accurately extracted from the sensing source data 720.

That is, processing the noise 610, 620, 630 before extracting first data by the data extractor allows the accurate extraction of first data. The ToF information 730 and other types of data that facilitate the determination of the distance to and location of the target object may be all used as first data.

On the other hand, when the sensing source data 720 is compressed and transmitted, only the electrical noise is removed and the ground reflection 610 or the n-th order reflection 620 remains intact because the reflection is needed to identify additional surrounding objects or parking environment.

To this end, according to the present invention, a second noise processor 140 that removes the electrical noise 630 from the sensing source data 720 may be further included. Specifically, the data compressor 110 may compress the sensing source data 720 from which the electrical noise 630 is removed through the second noise processor 140 to generate source compressed data.

Since the sensing source data 720 is downsampled to the source compressed data, in the case of the electrical noise 630, separating the noise 610, 620, 630 from the source compressed data is far more difficult than separating the noise 610, 620, 630 from the sensing source data 720. Accordingly, processing the electrical noise 630 first before generating the source compressed data by the data compressor 110 facilitates and ensures the separation of the noise 610, 620, 630.

On the other hand, the noise 610, 620, 630 received by the sensor is divided into reflection noise 610, 620 and electrical noise 630. The reflection noise 610, 620 adversely affects the obtention of distance information to a targeted hazardous object but is a waveform that helps determine the shape of the surrounding object and determining the surrounding driving situation and is to be included in the sensing source data 720 made up of raw waveform 400.

In contrast, the electrical noise 630 is a noise that has nothing to do with surrounding objects and the parking environment and needs to be removed as much as possible. Highly dense sensing source data 720 may be secured by eliminating the electrical noise 630, and the precision in determining the shape of the object and surrounding situation is thus enhanced.

For this reason, when first data such as the ToF information 730 is extracted, all the noise 610, 620, 630 is removed and the ToF information 730 is extracted and transmitted, and, in the case of the sensing source data 720, only the electrical noise 630 is removed to the minimum and the sensing source data 720 is extracted and transmitted. This allows the controller 200 to accurately determine the distance to the target and exactly know the surrounding environment information, including the target.

On the other hand, according to the present invention, a first noise processor 140 that removes from the sensing source data 720 reflection noise 610, 620 may be further included. Specifically, the data extractor 120 may extract first data from the sensing source data 720 from which reflection noise 610, 620 including diffuse reflection 610 by the ground or n-th order reflection 620 is removed through the first noise processor 140, and the data compressor 110 may compress the sensing source data 720 from which electrical noise 630 is removed through the first noise processor 140 and generate source compressed data.

That is, according to the present invention, the first noise processor 140 may remove both the reflection noise 610, 620 and the electrical noise 630, or may remove the electrical noise 630 only.

Eliminating both the reflection noise 610, 620 and the electrical noise 630 when extracting the first data that facilitates the determination of the distance to and shape of the target object allows the accurate extraction of first data. In addition, in the case of the sensing source data 720, eliminating only electrical noise 630 that is not related to the target object and surrounding situation allows the obtention of highly dense sensing source data 720 so that precision in determining the shape of the object and the surrounding situation is improved.

On the other hand, according to the present invention, terms such as ‘first’ or ‘second’ in the noise processor 140 are only meant to classify software in the processing of the noise 610, 620, 630 and do not imply that two noise processors 140 are necessarily provided in the form of hardware. That is, one noise processor 140 may perform the function of eliminating both the reflection noise 610, 620 and the electrical noise 630 from the sensing source data 720 and the function of eliminating only the electrical noise 630 from the sensing source data 720. Alternatively, two noise processors 140 corresponding to each of the functions may be provided to respectively remove the noise 610, 620, 630.

On the other hand, according to the present invention, the data transmitter 130 may transmit source compressed data and first data to the controller by a serial communication method, and the serial communication method allows transmission of both source compressed data and first data from the data transmitter 130 to the controller 200.

In the case of ultrasonic waves, since the propagation speed of the ultrasonic wave is relatively slow compared to the electromagnetic wave, measurement takes a lot of time. Accordingly, employing the serial communication method by which object detection and data communication may be simultaneously performed in real time allows measurement and data transmission at the same time so that the time spent on entire data transmission may be reduced. It is to be noted that data communication may be obviously performed after object detection by the serial data communication by which object detection and data communication may be performed simultaneously.

DSI3, PSI5, and other serial communication may be used for the serial communication, and DSI3 serial communication is described as an example in the present invention.

FIG. 9 shows that data is periodically transmitted from the sensor to the controller 200 at regular pulse intervals 710 after an object detection command 700 is transmitted in the DSI3 serial communication so that there is little possibility of the communication noise 610, 620, 630 entering during object detection. Accordingly, the object detection and communications functions may be simultaneously performed in real time in DSI3 communication so that the DSI3 communication may be used in the transmission of both the sensing source data 720 and the ToF information 730.

Further, The DSI3 serial communication is low-cost communication that reduces costs compared with CAN/LVDS/Ethernet communication and has a relatively high communication speed (444 kbps) so that a large amount of information may be quickly transmitted from the sensor to the controller 200.

On the other hand, according to the present invention, the data transmitter 130 may transmit first data during an idle period after measuring by the ultrasonic sensor 100.

In the case of ToF information 730, the ToF information 730 is to be extracted after the noise 610, 620, 630 is removed from the entire result measured during an object detection period so that the object detection and ToF information 730 transmission may not be simultaneously performed. Accordingly, even when the serial communication method by which the object detection and data communication may be simultaneously performed in real time is used, a problem is that the time spent on ToF information 730 transmission is added to the time spent on the object detection.

According to the present invention, the data transmitter 130 transmits the ToF information 730 to the controller during the idle period of the ultrasonic sensor 100 (the time before the next object detection command after the ultrasonic sensor detects an object and transmits the entire sensing source data 720 to the controller 200, about 10 ms) so that the total time spent on the object detection does not increase.

On the other hand, according to another embodiment of the present invention, a parking assistance system 300 including the ultrasonic sensor 100 of the present invention may include the controller 200 that receives the source compressed data and the first data from the data transmitter 130.

The reception by the controller 200 of both source compressed data and first data from the data transmitter 130 allows the reception of a larger amount of information compared with the reception of the source compressed data or the first data only. Further, the precision in determining the distance to the target object is improved based on the information of first data so that the precision of the detection result of the sensor is enhanced, compared with the transmission of the source compressed data only.

On the other hand, according to still another embodiment of the present invention, the controller 200 in the parking assistance system 300 including the ultrasonic sensor 100 may include a first processor that determines the shape of the object using the source compressed data and a second processor that determines the distance to the object using the first data.

The controller determines the shape of the target object and the surrounding situation using the received source compressed data received by the first processor and determines the distance to and location of the target object using the received first data by the second processor so that the information on the target object may be obtained more precisely than when only the source compressed data or first data is received.

On the other hand, according to still another embodiment of the present invention, the controller 200 in the parking assistance system 300 including the ultrasonic sensor 100 of the present invention may further include a third noise processor 140 processing the noise 610, 620, 630 of the source compressed data and generate the source compressed data free of electrical noise 630 removed through the third noise processor 140.

It is preferable to process the noise 610, 620, 630 by the sensor that may use high-precision data as much as possible, but the noise 610, 620, 630 may be removed by the controller 200 rather than the sensor when the shape of the object and the surrounding situation can be determined from low-precision data.

Specifically, since the sensing source data 720 is downsampled to the source compressed data, in the case of the electrical noise 630, separating the noise 610, 620, 630 from the source compressed data is far more difficult than separating the noise 610, 620, 630 from the sensing source data 720. Accordingly, processing the noise 610, 620, 630 first before generating the source compressed data by the data compressor 110 of the sensor facilitates the separation of the noise 610, 620, 630 and high-precision data may be obtained.

In contrast, when using low-precision data is acceptable, the controller 200 may be provided with noise 610, 620, 630 processing logic and separate the noise 610, 620, 630 signal from the source compressed data. In this case, the noise 610, 620, 630 processing logic is removed from the sensor so that the sensor may be made thinner, and manufacturing expenses and costs may be reduced.

FIG. 10 is a flowchart of a signal processing method of the ultrasonic sensor 100 according to the present invention.

A preferred embodiment of the signal processing method of the ultrasonic sensor 100 according to the present invention is described.

According to the present invention, a signal processing method of the ultrasonic sensor 100 includes compressing, by a data compressor, sensing source data to generate source compressed data (S100), extracting, by a data extractor, first data from the sensing source data (S200), and transmitting, by a data transmitter, the source compressed data and the first data to a controller (S300).

As described above, the sensing source data 720 is converted into a digital signal through the ADC 150, and a problem is that the amount of data increases in proportion to the sampling rate and resolution of the ADC 150 in the conversion process. Further, unless data is compressed, the bandwidth limitation of the ultrasonic sensor 100 necessitates the use of communication such as CAN/LVDS/Ethernet which is expensive communication and pushes up the sensor unit cost, and overall system cost increases.

In the step of compressing the sensing source data 720 to generate source compressed data, the data compressor 110 compresses the received sensing source data 720 to match the communication bandwidth such as to reduce the amount of data, thus allowing the use of existing low-cost communication, thereby holding down on costs. Further, generating, and transmitting to the controller 200, source compressed data allows transmission of a larger amount of information from the ultrasonic sensor 100 to the controller 200 compared with the transmission of uncompressed sensing source data 720. Accordingly, according to the present invention, the amount of data does not increase sharply, thereby saving the communication cost while safely securing all the data needed for determining the object.

In addition, when the sensing source data 720 is compressed, a problem is the loss of some information. This is because, in the case of data compression, tiny bits of information are removed and the spacing between frames is increased in the process of reducing the frame rate such that only rough data remains. The information loss in the process may decrease the precision in the determination of the distance to the target object. Accordingly, of the sensing source data 720, the first data that facilitates the determination of the distance to and location of the target object is essential data and is separately extracted without a data compression process and transmitted to the controller 200 so that information loss is prevented. Since the size of the first data is small, it may be fit for existing communication bandwidth even without a data compression process.

On the other hand, in the step of transmitting the source compressed data and the first data to the controller 200, the transmission of both the source compressed data and the first data to the controller 200 by the data transmitter 130 allows the transmission of a larger amount of information compared with the transmission of only the source compressed data or the first data to the controller 20. That is, compressing and providing the source data in addition to the first data allows simultaneous determination of the shape of the object. Accordingly, the controller 200 may determine the shape of the object and accurately determine the distance while acquiring data of small size.

Further, the precision in the determination of the distance to the target object is improved based on the information of the first data so that the precision of the detection result of the sensor is enhanced, compared with the transmission of the source compressed data only.

The ultrasonic sensor 100 according to the present invention is provided with two different signal processing paths referred to as the data compressor 110 and data extractor 120 and transmits both processed signal data by a data transmitter 130 to a controller 200, thereby complementing the advantages of each signal process path to enhance the precision of the detection result of the sensor.

Specific embodiments of the present invention are illustrated and described, but it will be obvious to those skilled in the art that the present invention may be improved upon and modified in various manners without deviating from the technical spirit of the present invention.

What is claimed is:

1. An ultrasonic sensor comprising:
a processor; and
a computer-readable medium in communication with the processor and storing instructions that, when executed by the processor, cause the processor to control the ultrasonic sensor to perform:
transmitting an ultrasonic signal toward an object;
receiving a reflection of the transmitted ultrasonic signal;
generating sensing source data based on the received reflection of the transmitted ultrasonic signal, the sensing source data including first data;
compressing the sensing source data to generate source compressed data;
extracting the first data from the sensing source data; and
transmitting, to a controller, the source compressed data and the first data.

2. The ultrasonic sensor of claim 1, wherein the first data includes data related to a time of flight (ToF).

3. The ultrasonic sensor of claim 2, wherein the instructions, when executed by the processor, further cause the processor to control the ultrasonic sensor to perform:
removing a noise from the sensing source data; and
extracting a ToF value from the sensing source data.

4. The ultrasonic sensor of claim 1, wherein the instructions, when executed by the processor, further cause the processor to control the ultrasonic sensor to perform eliminating, from the sensing source data, a reflection noise including a diffuse reflection by a ground or an n-th order reflection.

5. The ultrasonic sensor of claim 1, wherein the instructions, when executed by the processor, further cause the processor to control the ultrasonic sensor to perform eliminating an electrical noise from the sensing source data.

6. The ultrasonic sensor of claim 1, wherein the instructions, when executed by the processor, further cause the processor to control the ultrasonic sensor to perform eliminating a reflection noise from the sensing source data, the reflection noise including (1) a diffuse reflection by a ground or an n-th order reflection, or (2) an electrical noise.

7. The ultrasonic sensor of claim 1, wherein, for transmitting the source compressed data and the first data, the instructions, when executed by the processor, further cause the processor to control the ultrasonic sensor to perform serially transmitting the source compressed data and the first data.

8. The ultrasonic sensor of claim 1, wherein, for transmitting the source compressed data and the first data, the instructions, when executed by the processor, further cause the processor to control the ultrasonic sensor to perform transmitting the first data during an idle period of the ultrasonic sensor

9. A parking assistance system including the ultrasonic sensor of claim 1, the system comprising the controller configured to receive, from the ultrasonic sensor, the source compressed data and the first data.

10. The parking assistance system of claim 9, wherein the controller is configured to determine a shape of the object based on the received source compressed data and determine a distance to the object based on the received first data.

11. The parking assistance system of claim 9, wherein the controller is further configured to eliminate a noise from the source compressed data.

12. A method of operating an ultrasonic sensor, comprising:
transmitting an ultrasonic signal toward an object;
receiving a reflection of the transmitted ultrasonic signal;
generating sensing source data based on the received reflection of the transmitted ultrasonic signal, the sensing source data including first data;
compressing the sensing source data to generate source compressed data;
extracting the first data from the sensing source data; and
transmitting, to a controller, the source compressed data and the first data.
